(19) United States
(12) Patent Application Publication
(10) Pub. No.: US 2009/0070588 A1
(43) Pub. Date: Mar. 12, 2009

(54) RENEWABLE WATERMARK FOR THEATRICAL CONTENT

(75) Inventor: Antonius Adriaan Maria Staring, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/298,073

(22) PCT Filed: Apr. 20, 2007
(86) PCT No.: PCT/IB2007/051459

§ 371 Date: Oct. 22, 2008

(30) Foreign Application Priority Data
Apr. 25, 2006 (EP) 06113018.3

(51) Int. Cl. H04L 9/00

(52) U.S. Cl. 713/176

(57) ABSTRACT

The present invention relates to a method for a content provider of renewing the watermarking of theatrical content and for updating consumer devices to detect said renewed watermark, wherein a watermark is embedded in said theatrical content using at least a first watermark noise pattern. Renewing is performed by said content provider distributing at least a second watermark noise pattern, which is used for embedding and detecting said watermark in said theatrical content, to said consumer devices using a broadcast encryption technology. The invention further relates to a content provider system adapted to be used for renewing the watermarking of theatrical content and for updating consumer devices to detect said renewed watermark.

### FIELD OF THE INVENTION

The present invention relates to a method for a content provider of renewing the watermarking of theatrical content and for updating consumer devices to detect the renewed watermark. The invention further relates to a content provider system adapted to be used for renewing the watermarking of theatrical content and for updating consumer devices to detect said renewed watermark

### BACKGROUND OF THE INVENTION

Typically, the audio-visual media industry markets its content in a number of stages. For example, the major movie studios first release their content for display in movie theatres only; next, the movies become available on DVD in video rental stores; and finally, DVDs go on sale for the general public. Whereas the content is distributed on media carriers that provide protection against illicit copying—professional celluloid tape in the case of movie theatres (in the case of digital cinema, distribution may occur through completely electronic means instead of physical media carriers) and copy-protected discs in the case of DVDs—ultimately, the output of the media player or rendering device is unprotected because otherwise humans would not be able to watch and listen to the content. For example, if a movie is projected onto the white screen of a theatre, there obviously is no protection against copying in place any more. As a result, it is straightforward to make a copy using a personal camcorder, which is smuggled in and out of the theatre (with or without help from theatre employees). The thus made copy can easily be reproduced and distributed on illegal DVDs. These illegal discs compete with the theatres and official DVDs, causing lost sales to the original content owners. Note that illegitimate copies can also be made by directly recording the analog signal from a media player (e.g. a DVD player)—this may require the use of a “signal cleaner” to remove analog copy protection measures, such a Macrovision signal.

Whereas it is impossible to prevent illegitimate copies from being made, it is possible to prevent, or at least obstruct, those illegitimate copies from being played in consumer devices such as DVD players. The technology that is used for this purpose is based on digital watermarking. A watermark is a signal that is added to the audio visual content, in such a way that humans do not perceive a difference compared to the original, non-watermarked, content. Typically, the watermark comprises a noise pattern, and may carry a payload that indicates the intended use of the original copy, e.g. “this content is for playback in a movie theatre only.” Consumer devices can detect the presence of the watermark in the content by means of correlation techniques while playing. As soon as the player has found the watermark (and its payload) and it recognizes the content as illegitimate, it aborts playback and typically ejects the disc. Note that for this scenario to work, in the case of a watermark that is added to the video, the watermark signal should be strong enough to survive the steps of projecting onto a movie theatre's white screen and subsequent recording by a personal camcorder. In the case of a watermark that is added to the audio, the watermark signal should be strong enough to survive the path from the movie theatre's loudspeakers to the camcorder's (or audio recorder's) microphone.

It may be evident that this scenario requires a standardized watermark: all players have to correlate using the same noise pattern that was used to add the watermark. Here also lies the Achilles' heel of this system: once a determined hacker has been able to reverse engineer a player and obtain the noise pattern, the system is broken completely. The reason is that a hacker can use the noise pattern to create a tool that removes the watermark from the illicit copy, without unacceptably deteriorating the quality of that copy. The result is a “cleansed” copy which does not cause the watermark detector in a consumer player to trigger and eject the disc. Therefore, as before, the cleansed illicit copy can be reproduced and distributed on DVDs or over the Internet. In addition to distributing cleansed copies, the hacker may also publish, e.g. on the Internet, the tool in the form of a software application that executes on a personal computer. This allows everyone to create cleansed copies.

In order to frustrate hackers as much as possible, the noise pattern is usually deeply embedded in the hardware of a consumer player. This means that hackers need to use “professional” tools in order to retrieve the noise pattern. Unfortunately, there will always be a few hackers who have access to such tools, so that it may be expected that eventually the noise pattern will be discovered, and a cleansing tools will appear on the Internet.

A simple method to maintain at least some effectiveness of the watermark-based protection system described above is that one could standardize not a single noise pattern, but multiple noise patterns. In this enhanced system, the content owners would add multiple watermarks to the content (using each of the standardized noise patterns), and individual consumer players would scan for a single one of these watermarks. For this purpose, each consumer player would comprise a single one of the standardized noise patterns which is for example assigned randomly at manufacturing time. The result of this approach is that if one consumer player is hacked, i.e. its noise pattern is revealed, this is of no consequence for players which use one of the other noise patterns. For example, if the system uses 100 unique noise patterns, 99% of the system would still be intact after a single player has been hacked. Note that a by-effect of this system is that players, which contain the compromised noise pattern, become more valuable to consumers, since those players can be used to play (partially) cleansed content.

A problem that still remains with this simple method is that it is not possible to recover from a security breach. This means that it is not possible to restore security for any player that contains one of the compromised noise patterns. As a result, the security of the system degrades with time as additional players are hacked.

### OBJECT AND SUMMARY OF THE INVENTION

The object of the present invention is to alleviate at least some of the above problems.

This is obtained by a method for a content provider of renewing the watermarking of theatrical content and for updating consumer devices to detect said renewed watermark, wherein a watermark is embedded in said theatrical content using at least a first watermark noise pattern. The renewing is performed by said content provider distributing at least a second watermark noise pattern, which is used for embedding and detecting said watermark in said theatrical content, to said consumer devices using a broadcast encryption technology.

Thereby an effective method is obtained for watermarking where, if a watermark noise pattern is compromised, the watermarking can be easily renewed from the content provider side. Using broadcast encryption for distribution is a cheap, efficient way to get the patterns to only authorized devices. In particular, a revoked device will not be able to access something that is broadcast-encrypted, so they will not gain access to the new pattern. Thereby the value of compromised devices is lowered.

In an embodiment a consumer device on which the first watermark noise pattern has been compromised is identified by said content provider, and said second watermark noise pattern is not distributed to said identified device. Thereby the hacked device does not receive the renewed watermark noise pattern. This ensures that the renewed watermark noise pattern is not received by the hacked device whereby the hacked device is not able to compromise the renewed watermark.

In an embodiment said watermark is embedded in said theatrical content using a plurality of watermark noise patterns comprising said first and second watermark noise pattern. Thereby if there is a hack of one of the watermark noise patterns, then only the fraction of consumer devices using the watermark noise pattern is affected.

In an embodiment said renewing comprises embedding said watermark in said theatrical content using both said first watermark noise pattern and said second watermark noise pattern. Thereby consumer devices which have not yet been updated to use the second watermark noise pattern will still be able to access the watermarked content.

In an embodiment broadcast encryption technology uses an encryption key block structure for encrypting the noise patterns to be distributed where each key of said key block are assigned to groups of consumer devices, and wherein a new key block is used when renewing. Encryption key block structures form an advantageous way of performing broadcast encryption in the present invention, since the key block can be updated when renewing, which is necessary because a watermark noise pattern has been compromised.

In an embodiment the encryption block structure is based on a hierarchical tree. This is an easy way of managing devices in a key block structure.

In an embodiment the noise patterns are distributed from the content provider to the consumer devices using a network connection. This is a simple way of distributing the noise patterns.

In an embodiment the noise patterns are distributed from the content provider to the consumer devices using media carriers. This is another advantageous way of distributing noise patterns which makes it possible to distribute to devices not connected to a network.

The invention further relates to a content provider system adapted to be used for renewing the watermarking of theatrical content and for updating consumer devices to detect said renewed watermark, wherein a watermark is embedded in said theatrical content using at least a first watermark noise pattern. The content provider device comprises renewing means for distributing at least a second watermark noise pattern, which is used for embedding said watermark in said theatrical content, to said consumer devices using a broadcast encryption technology.

### BRIEF DESCRIPTION OF THE DRAWINGS

In the following, preferred embodiments of the invention will be described referring to the figures, where

FIG. 1 illustrates a consumer player, which detects watermarked content,

FIG. 2 illustrates an example of a broadcast encryption system where the keys are organized in a binary tree,

FIG. 3 illustrates a first embodiment of the present invention,

FIG. 4 illustrates a second embodiment of the present invention.

### DESCRIPTION OF PREFERRED EMBODIMENT

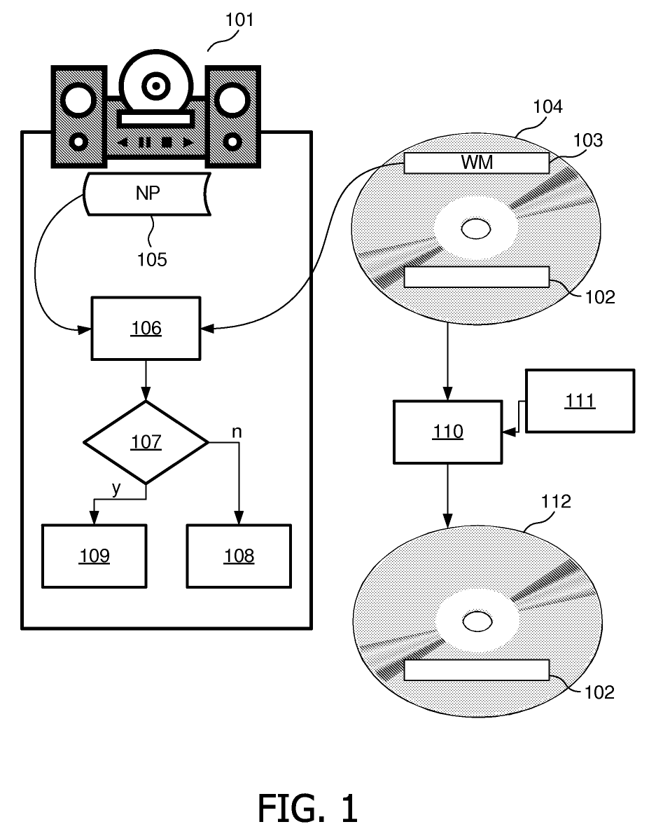

FIG. 1 illustrates a consumer player (101) that scans content (102) for the presence of a watermark (103) while playing a media carrier (104). The media carrier could for example consist of an optical disc, a magnetic disc, a magnetic tape, or a solid state memory. Note that the consumer player (101) may also retrieve the content (102) from a network server, e.g. using a streaming mechanism, instead of reading it directly off a media carrier (104). In the latter case, the network server would typically have physical access to the media carrier (104). Content that is distributed on commercial mass-market media carriers, and personal recordings do not contain a watermark, should be played without limitation. Illicit recordings, for example recordings of theatrical content, are watermarked and should not play on a consumer player. In order to distinguish between legitimate and illegitimate content, the consumer player comprises a watermark detector (106) which correlates the content (102) with a noise pattern (105) that is contained in the player. This noise pattern is identical to the one that content owners have used to add the watermark to the content. Typically, the watermark detection process runs continuously during playback of the content. As soon as the result of the watermark detection process becomes available, the player decides (107) to interrupt playback or not. If the watermark was not found in the content, playback continues without interruption (108). If the watermark, and optionally its payload, has been retrieved from the content, playback will be interrupted (109) and the media carrier will e.g. be ejected from the player. The player may decide to interrupt playback based on the mere presence of the watermark in the content, or, alternatively, based on the payload of the watermark. For example, the payload may indicate that the content was intended for theatrical use only and should never be played on a consumer player. In that case, the player would abort playback. As another example, the payload may indicate that playback may be continued after the consumer has made a payment. These two examples are indicative of the “usage rights” that may be encoded in the watermark payload. Many other usage rights are conceivable as well.

A skilled hacker would be able to reverse engineer the noise pattern (105) from a consumer player (101) and use it to construct a tool (110) which can remove the watermark from the content. The reason that this is possible is that content owners have to use the same noise pattern to add the watermark to the content in the first place. Alternatively, the hacker's tool (110) may be designed to change the payload of the watermark such that it encodes different usage rights, e.g. “this content may be used without restrictions.” The tool (110) may take the form of a software application that executes on a personal computer. This facilitates distribution of the tool via the Internet to a huge number of unskilled consumers. The result is that those unskilled consumers can profit from the hacker's expertise to remove or modify (111) the watermark that is embedded in any illicit copy of content they may have acquired and subsequently produce media carriers (112) containing illicit content that plays without interruption because consumer players would either not find a watermark or find a watermark with a payload that specifies liberal usage rights.

The prior art employs a single, standardized watermark, for example by specifying a single noise pattern that is both used to add the watermark to the content and to detect the watermark in the content. This means that the system secret, i.e. the noise pattern, is present in all consumer players. Robustness rules for the implementation of consumer players state that this secret should be stored in the player in such a way that it can be retrieved only with great difficulty and preferably using professional tools only. The conventional approach to satisfy this requirement is to bury the noise pattern deeply within the hardware of the consumer player. However, this does not guarantee that reverse engineering of the noise pattern is impossible. Once the noise pattern is reverse engineered, the watermark system is broken completely.

A solution to this problem is to make the noise pattern truly renewable. This means that whenever a noise pattern is revealed, it should be possible to switch to a new noise pattern. Since a consumer player obviously cannot store all noise patterns in advance—a hacker would reverse engineer those noise patterns along with the first used noise pattern—the new noise pattern must be communicated to the consumer players (that have not been hacked). In addition, a consumer player must contain means to store the new noise pattern. Preferably, this storage means should be constructed such that it frustrates attempts to retrieve or wipe out the stored noise pattern. For example, the player could comprise non-volatile memory such as flash memory or EEPROM to store the noise pattern. In order to keep the confidentiality of the noise pattern, the consumer player could comprise a cryptographic key that is buried deeply within its hardware. In addition, the consumer player could comprise a mechanism that disables playback functionality if the storage means does not contain a valid noise pattern. In addition to the storage means, the consumer player must also comprise communication means to receive the new noise pattern. This communication means could comprise a network connection, which the consumer device uses regularly to poll a server on the Internet in order to determine if the noise pattern should be updated. Such a network connection could, e.g., be based on Ethernet, WiFi, BlueTooth, or GSM. The confidentiality of the communication over such a network connection should be protected using well-known techniques comprising authentication and encryption. Media carriers provide an alternative communication channel. For example, the new noise pattern could be stored on DVDs containing commercial, mass-market content. Alternatively, the new noise pattern could be stored on blank recordable discs, either by pre-recording or other means. For example, on a DVD+RW disc, the pre-groove provides a data channel (ADIP) that can be used advantageously. To provide the confidentiality of the noise pattern, which is communicated via media carriers, a broadcast encryption technology should be used.

Broadcast encryption provides a mechanism to selectively update groups of consumer players. For this purpose a key distribution center defines a large number of groups of players, and in addition, assigns a cryptographic key to each of those groups. These cryptographic keys are also known as group keys. Each player must store the group keys of all groups that it is a member of. Also, a player should be uniquely identifiable, which means that two players should not store an identical set of group keys. Whenever it is time to distribute a new noise pattern, the key distribution center selects a set of groups of players that should start to use the new noise pattern. Typically, this set is chosen such that it does not include any known hacked player. In addition, the key distribution center advantageously tries to minimize the number of groups in the set. The key distribution center is able to achieve a high efficiency by defining the initial player groups in a structured way. For example, the first group comprises all players that will ever be manufactured; the second and third groups each comprise half of all players; the fourth to seventh groups each comprise a quarter of all players; and so on, up to the last groups, which each comprise a single player only.

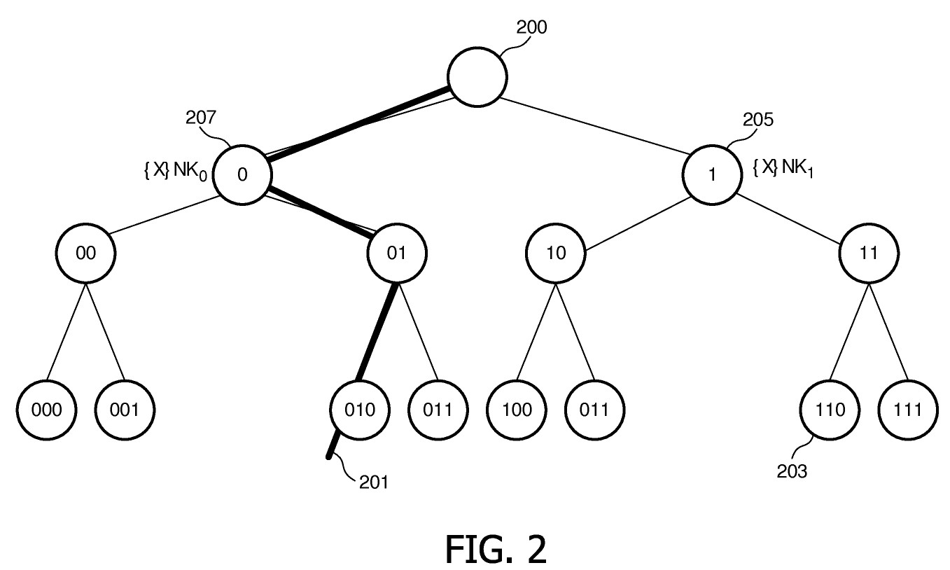

FIG. 2 illustrates an example where the node keys are organized in a binary tree. Each node 205 in the tree holds a node key (NK). A device key is the set of node keys in the path 201 from a leaf node to the root, and the root node 200 is not used and a device is identified by a device ID 203, which is equal to the ID of the leaf node (inside the circle). Based on this, a key block (EKB) is made being a list of encrypted keys {X}NK₀ and {X}NK₁, X being the key and NK being the node key used to encrypt X. When e.g. a product with Device ID 010 has been revoked, then its node keys cannot be used anymore, and a new EKB is generated that uses the node keys 1, 00, and 011.

The key issuance center encrypts the noise pattern using each of the group keys that are contained in the set. Alternatively, the key issuance center encrypts the noise pattern using a randomly chosen key and encrypts the latter key using each of the group keys that are contained in the set. The key issuance center then formats the encrypted noise patterns into a so-called key block, which subsequently will be distributed on media carriers. In addition to the encrypted noise patterns, the key block should comprise information on the order of their issuance, e.g. a sequence number or date of issuance, as well as information that vouches for the authenticity of the key block, e.g. a digital signature. The order of issuance is important, since players should be using the noise pattern communicated by the most recently issued key block that the player has encountered.

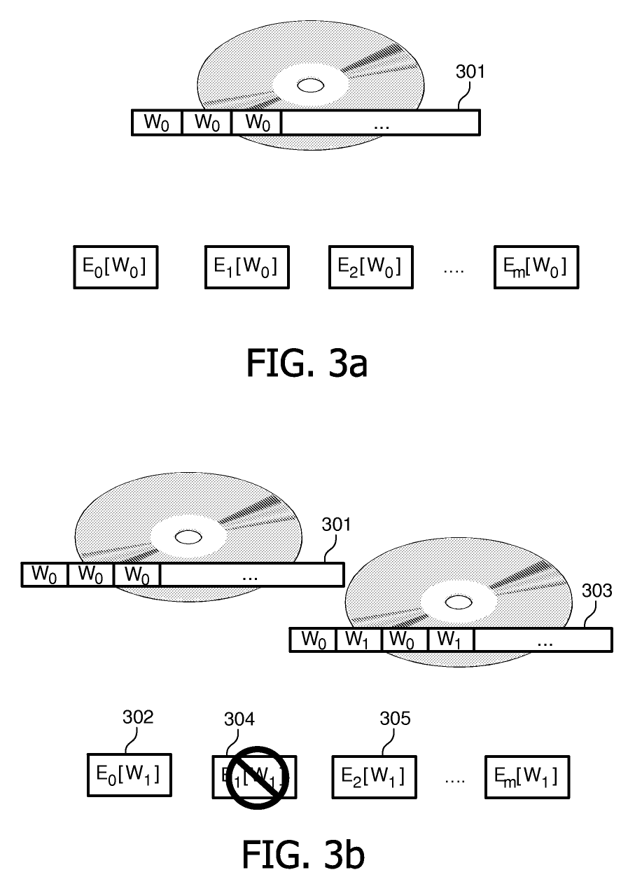

FIG. 3 illustrates an embodiment of the present invention. FIG. 3a illustrates the initial situation, in which there are no hacked players. All theatrical content (301) is watermarked using the initial noise pattern W₀. Typically, the watermark is repeated throughout the content.

In this initial situation, all consumer players should be able to detect the watermark using the noise pattern W₀. The key distribution center therefore selects a set of groups that includes all players and encrypts the noise pattern using the group keys that are assigned to this set of groups and formats the encrypted noise patterns into a key block (E₀ . . . Eₘ). Distribution of the encrypted noise patterns W₀ may occur by means of application of the key block on media carriers, such as DVDs, by means of network connections or by other means known to those skilled in the art. Whenever players receive a key block that communicates a new noise pattern, i.e. a noise pattern that is more recently issued than the noise pattern the player has been using so far, the player should store the new noise pattern. Moreover, the player should start to use the new noise pattern when searching for a watermark in content. Typically, the initial noise pattern W₀ is communicated to players during or directly after manufacturing.

FIG. 3b illustrates a situation in which a player has been hacked, e.g. because a hacker obtained one or more of its group keys, and the noise pattern W₀ has been revealed. In addition, the hacker may have constructed and distributed a tool to remove the watermark from the theatrical content. Once the owners (e.g. movie studios) of theatrical content know that a noise pattern has been revealed, and preferably also know which group key the hacker has obtained, new theatrical content (303) is watermarked using a new noise pattern W₁ as well as the old noise pattern W₀.

In this new situation both old theatrical content (301), where the watermark has been embedded using only noise pattern W₀, and new theatrical content (303), where the watermark has been embedded using noise pattern W₀ and W₁, exist. In addition, the new noise pattern W₁ is being distributed, e.g. using a broadcast encryption technology. Preferably, the key block of the broadcast technology used for this purpose is constructed such that all players, except the known hacked player (304), are able to decrypt the new noise pattern W₁. The distribution of the new noise pattern may occur via many different channels, such as (optical) discs, (flash) memory modules, broadcast channels, the Internet etc., and in addition it would take time for all players to be updated. Therefore, there are devices that have not yet been updated and which are still using the old compromised noise pattern W₀ (category A devices), and there are devices that have been updated and are using the new noise pattern W₁ (category B). Note that the initially large number of devices in category A is the reason that W₀ is embedded in new theatrical content because, even though W₀ has been compromised, some effectiveness may still be left (e.g., not everyone will use the hacker's tool; the hacker's tool may not be perfect). As more and more devices are updated, the original effectiveness of the watermarking system is restored for new content. On the other hand, for old content this is not the case. In fact, once all players have been updated to the new noise pattern W₁, effectiveness of the watermarking system for old content may be reduced to zero (if players will no longer search for a watermark using noise pattern W₀). However, because the content is “old,” its value is expected to be lower than that of the new content. Content owners may consider this a fair trade-off. Alternatively, players may be required to store one or more of the old noise patterns in addition to the new noise pattern and search for a watermark using all of the stored noise patterns.

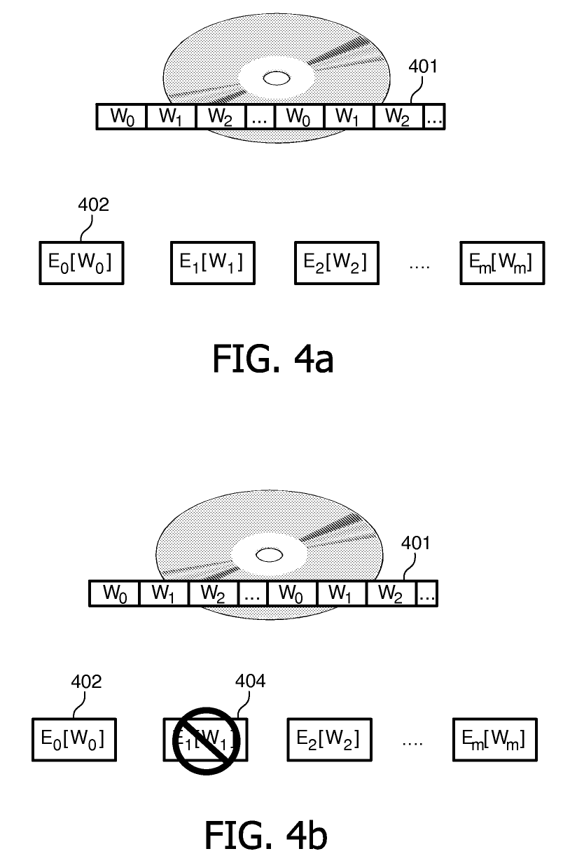

FIGS. 4a and 4b illustrate the renewability of the theatrical watermark according to a second embodiment. FIG. 4a illustrates the initial situation in which there are no hacked players. The difference compared to the first embodiment illustrated in FIGS. 3a and 3b is that there are multiple watermarks embedded in the content 401 from the start. In addition, the key block is constructed such that different groups of players search for a different watermark. This can be achieved simply by encrypting a different noise pattern using each of the group keys. For example, if the theatrical content comprises m watermarks, the key distribution center would construct a key block from m or more groups of players and use the associated group keys to encrypt the m different noise patterns 402. The advantage of this approach is that if a single player has been hacked, and the noise pattern that is associated with the hacked player's group has been published, only of fraction of all devices are affected. This means that the effectiveness of the watermark system remains largely intact.

FIG. 4b illustrates a situation in which a player has been hacked, e.g. because a hacker obtained one or more of its group keys, and the associated noise pattern has been revealed. In addition, the hacker may have constructed and distributed a tool to remove the watermark from the theatrical content. Once the owners (e.g. movie studios) of theatrical content know that a noise pattern has been revealed, and preferably also know which group key 404 the hacker has obtained, new key blocks constructed by the key distribution center will no longer make use of the hacked watermark. Thus, until all watermarks have been compromised, full effectiveness of the watermark system can be restored for both old and new content.

Hybrids of the two embodiments described above using FIGS. 3 and 4 are also possible. For example, in the first embodiment it is possible to embed additional watermarks from the start. This allows the effectiveness of the watermark system to be restored for old content as well, because in this situation the “old” content already contains the “new” watermark. Likewise, in the second embodiment the comprised watermarks may be replaced in new content with completely new watermarks (e.g. W₁ may be replaced with W₁′). This provides a way to migrate to a new set of watermarks, similar to the approach used in the first embodiment.

The above embodiments have been described taking a consumer player as an example, where the watermark system is used to implement a form play control, i.e. if the content comprises a watermark, the player is supposed to refrain from further playback of the content. It may be evident to those skilled in the art that similar embodiments exist for a consumer recorder. In that case, the watermark system is used to implement a form of record control, i.e. if the content comprises a watermark, the recorder is supposed to refrain from continuing the recording.

1. A method for renewing the watermarking of theatrical content and for updating consumer devices to detect said renewed watermark, wherein a watermark is embedded in said theatrical content using at least a first watermark noise pattern, wherein said renewing is performed by distributing at least a second watermark noise pattern, which is used for embedding and detecting said watermark in said theatrical content, to said consumer devices using a broadcast encryption technology.

2. The method according to claim 1, wherein a consumer device, on which the first watermark noise pattern has been compromised, is identified and said second watermark noise pattern is not distributed to said identified device.

3. The method according to claim 1, wherein said watermark is embedded in said theatrical content using a plurality of watermark noise patterns comprising said first and second watermark noise pattern.

4. The method according to claim 1 wherein said renewing comprises embedding said watermark in said theatrical content using both said first watermark noise pattern and said second watermark noise pattern.

5. The method according to claim 1, wherein the broadcast encryption technology uses an encryption key block structure for encrypting the noise patterns to be distributed where each key of said key block are assigned to groups of consumer devices, and wherein a new key block is used when renewing.

6. The method according to claim 5, wherein the encryption block structure is based on a hierarchical tree.

7. The method according to claim 1, wherein the noise patterns are distributed to the consumer devices using a network connection.

8. A method according to claim 1, wherein the noise patterns are distributed from to the consumer devices using media carriers.

9. A content provider system for renewing the watermarking of theatrical content and for updating consumer devices to detect said renewed watermark, wherein a watermark is embedded in said theatrical content using at least a first watermark noise pattern, wherein said content provider device comprises renewing means for distributing at least a second watermark noise pattern, which is used for embedding said watermark in said theatrical content, to said consumer devices using a broadcast encryption technology.
